(19) United States
(12) Patent Application Publication
(10) Pub. No.: US 2022/0364515 A1
(43) Pub. Date: Nov. 17, 2022

(54) ADAPTED PROCESS CONCEPT AND PERFORMANCE CONCEPT FOR ENGINES (E.G. ROCKETS), AIR-BREATHING PROPULSION SYSTEMS (E.G. SUBSONIC RAMJETS, RAMJETS, ROCKET RAMJETS), TURBOPUMPS OR NOZZLES (E.G. BELL NOZZLES, AEROSPIKES)

(71) Applicant: Mathias Herrmann, Erfurt (DE)

(72) Inventor: Mathias Herrmann, Erfurt (DE)

(21) Appl. No.: 17/656,459

(22) Filed: Mar. 25, 2022

(30) Foreign Application Priority Data
Mar. 31, 2021 (DE) DE102021001689.0

(51) Int. Cl. F02C 7/264; F02K 9/95; F23R 3/40

(52) U.S. Cl. CPC F02C 7/264; F02K 9/95; F23R 3/40

(57) ABSTRACT

Chemical thrusters convert chemical energy predominantly into thermal energy and further into kinetic energy. These conversions are lossy and typically limit the usable thrust to 40-70% of the chemical energy (rockets). The exit velocity is maximized by increasing the temperature. However, temperature cannot be increased at will and can increase losses. Thrusters also have limited controllability under changing external conditions. The options for isochoric or detonative combustion are limited. This concept is intended to increase efficiency and controllability.

Through changes in catalytic loads and electromagnetic dose, combustion is increased and can be selectively regulated. Pressure/temperature are influenced and can be adapted e.g. to the changing external pressure. The achievable thrust increases due to the higher exit velocity. Further advantages exist. The geometry of combustion chambers can be optimized (e.g. smaller, more efficient). The concept is particularly promising for detonation engines or novel supersonic combustors.

### CROSS REFERENCE TO RELATED DOCUMENTS

The present application claims priority to provisional patent application number DE 10 2021 001 689.0 filed on Mar. 31, 2021 in Germany, disclosure of which are intercorporated herein at least by reference.

This patent application covers overriding issues and intersections with catalytic combustion chamber optimization (U.S. patent application Ser. No. 17/650,537 from the same patent applicant) and electromagnetic ignition (U.S. patent application Ser. No. 17/653,910 from the same patent applicant).

### No Patent Literature:

[1] Ernst Messerschmid et al: Raumfahrtsysteme; 4. Auflage, 2011, ISBN 978-3-642-12816-5
[2] Antonella Ingenito: Subsonic Combustion Ramjet Design, 2021, Springer, ISBN 978-3-030-66880-8
[3] Reinhard Müller: LUFTSTRAHLTRIEBWERKE—GRUNDLAGEN, CHARAKTERISTIKEN, ARBEITSVERHALTEN; Viehweg, ISBN 978-3-322-90325-9, 1997
[4] Matthias ZiefuB (Seminar paper): Dual-Bell-Diise; DLR; Deutsches Zentrum für Luft und Raumfahrt e.V. Institut für Raumfahrtantriebe Jan. 15, 2016
[5] Jörg Hahn (Thesis): Untersuchungen der Reaktion von Wasserstoffatomen mit Sauerstoffmolekülen (H+O₂+M→HO₂+M) in weiten Druck-und Temperaturbereichen; Uni Göttingen, 2003
[6] https://www.pleiger-laserotpik.de/metallische-beschichtungen/
[7] Ralf Stark (Thesis): Beitrag zum Verständnis der Strömungsablösung in Raketendüsen; RWTH Aachen; 2010
[8] https://www.dbu.de/123artikel32080_555.html from 03/22/2022
[9] https://www.enargus.de/pub/bscw.cgi/d3781-2/*/*/Flammenlose %20Oxidation.html?op=Wiki.getwiki from Mar. 22, 2022
[10] Kurt Eckerstorfer (Master Thesis): Auslegung und Konstruktion eines Prüfstands zur katalytischen Umsetzung von Wasserstoff; TU-Graz; August 2015
[11] Dipl.-Ing. Matthias Endisch (Thesis): Experimentelle und numerische Untersuchungen zur stabilen Entsorgung von Schwachgasen in porösen Verbrennungsreaktoren; Feb. 8, 2013; TU Bergakademie Freiberg
[12] Tomasz Palacz: Nitrous Oxide Application for Low-Thrust and Low-Cost Liquid Rocket Engine; AGH Space Systems
[13] Saxena Samveg (Thesis): Maximizing Power Output in Homogeneous Charge Compression Ignition (HCCL) Engines and Enabling Effective Control of Combustion Timing; University of California 2011
[14] Dipl.-Ing.; Neda Djordjevic (Thesis): “Flammenstabilisierung durch Verbrennung in festen Schwfmmen”; TU-Karlsruhe; Jan. 14, 2011
[15] Stuart James Barkley (Thesis): Microwave enhancement of energetic materials combustion through gas-phase flame flame interactions; Iowa State University; 2020
[16] Kline et. Al: Spatially focused microwave ignition of metallized energetic materials, Journal of Applied Physics 121, 055901, 2020
[17] Jing Sun et. al.: “Review on Microwave-Matter Interaction Fundamentals and Efficient Microwave-Associated Heating Strategies”; Materials 2016, 9, 231; www.mdpi.com/journal/materials

### BACKGROUND OF THE INVENTION

### 1. Field of the Invention

The present invention relates to the field of aerospace, consisting of optimization of the combustion chamber of chemical engines by variable freight rates of catalytic absorbers at variable electromagnetic dose rate (e.g., microwaves).

### 2. Discussion of the State of the Art

According to the “principle of least constraint” (Le Chatelier's principle), chemical reactions are affected by: Pressure, temperature and proportions of substances. In principle, chemical reactions are accelerated at high combustion temperature. According to the general school, isobaric combustion maximizes the combustion temperature of engines to achieve the highest possible exit velocity. This principle is referred to in the following as thermo-chemistry (here for jet engines).

In general, the following applies to chemical engines and energy machines/engines:

The conversion of the chemically bound energy from the reducing agent and oxidizer provides predominantly thermal energy. Further kinetic energy becomes usable through lossy conversion. This is because it is only through the lossy thermodynamic change of state at the nozzle throat and the nozzle that a further part of this thermal energy is converted into usable kinetic energy in the direction of thrust.

According to the state of the art, large chemical drives typically deliver 40-70% of the power expended (chemically bound energy) as usable thrust [1].

In steady-state combustion processes, some combustion is flameless [9]. For example, in the FLOX process, the gas is injected into the combustion chamber so rapidly that no stable flame front can develop. “FLOX” refers to “flameless oxidation.” At the same time, the endothermic generation of pollutants such as nitrogen oxides is largely avoided and fuel is significantly saved. In this way, fuel requirements in power plants, for example, can be significantly reduced. In relevant industrial burners, fuel use can be reduced by 15 to 20%, while at the same time utilizing the waste gas heat. This was recognized with the German Environmental Award in 2011. For air-breathing engines, there is as yet no technical reference for this, but this is a long-term vision of the already successful inventors of the FLOX process. This patent specification, or process concept, is aimed at other technical possibilities for creating correspondingly effective conditions in air-breathing engines (e.g. increasing the combustion speed, saving fuel).

The patent specification EP 1 833 594 B1 “catalytic combustion reaction” refers to the fact that catalysts can be used to better exploit the energy density in fuels. The thermal efficiency increases in the percentage range. The patent specification focuses on hydrocarbons.

For the use of metal parts in the combustion chamber, ternary systems/triergol systems are known for liquid rocket engines (oxidizer, reducing agent and metallic component/s). These ternary systems/triergol systems use metal parts to increase thrust. In vehicles, metals are also used in fuels as homogeneous catalysts, or additives. Patent specification WO001995004119A1—FUEL ADDITIVES points out that iron and manganese, or copper, can cause damage to the automotive engine. Therefore, the patent specification prefers alkali/alkaline earth, rare earth metals. These are introduced in dissolved form (Lewis bases).

In the aerospace sector, electromagnetic absorber materials have so far only been researched and tested as energetic materials (metals) directly with electromagnetic waves. However, these energetic metals with their own calorific value predominantly require relatively high electrical ignition powers and effective times.

In [16] it is stated that absorbers for microwaves can be used as support or carrier for catalysts or catalytic microwave reactions in general. For example, carbon materials that can be loaded with metallic components are cited for this purpose. Environmental remediation, reforming, pyrolysis, and biosynthesis are specifically mentioned as potential applications. In other parts of the source, material processing is also mentioned.

According to U.S. patent application Ser. No. 17/653,910 of the applicant of the same name, metallic particles can be used in addition to catalytic absorbers. In this way, combustion can be supported, stimulated or enhanced. The metallic particles do not primarily serve to couple/absorb electromagnetic radiation (e.g. microwaves). However, they can be used magnetically or energetically. This can be achieved, for example, by an appropriate size of the metallic particles (≥ several micrometers in diameter). This is because electromagnetic radiation (e.g. microwaves) is shielded from a certain layer thickness in metals. This is several micrometers in diameter.

### 2.1 Disadvantages of the State of the Art

The combustion temperature cannot be increased at will (e.g. due to the limited heat resistance of materials on the engine and the increasing cooling requirements). In addition, the energetic losses of the engine increase due to:
1. thermal losses,
2. stronger dissociation at the end of the engine,
3. higher friction in case of required constriction,
4. higher friction in the engine,
5. higher divergence losses of the nozzle, etc.

Thermodynamic conversions, e.g. of thermal energy into usable thrust, are basically lossy or possible only up to a maximum. The higher the thermodynamic conversion, the higher the losses.

Also, the acceleration of a chemical reaction is limited by the temperature alone. In the case of air-breathing engines, efficiency is limited by various factors. In particular, diminishing effects such as:
1. reduced burnout of atmospheric oxygen and injected fuel,
2. thermal coheating of inert air components such as nitrogen in the combustion chamber, especially at high combustion temperatures.
3. Increased dissociation at high temperatures and unfavorable slow combustion are also disadvantageous.
4. Excessive temperatures and unwanted backpressure can also cause thermal blockage of the inlet of the respective engine due to the backpressure of the combustion chamber. As an unfavorable consequence, there is a risk of scavenging of the air-breathing engine, or a drop in engine thrust and unsafe, or fluctuating, operating conditions. Here, for example, the concentration of fuel in the combustion chamber due to unburned residues can lead to undesirable peaks in combustion.

Also, by keeping the design of the engines as simple and robust as possible (e.g. air-breathing engines), the operating limits and permissible operating conditions are restricted.

According to [2] page 63, for example, the burnup of fuel for subsonic ramjets in the range from 0.49 to 1.46 Mach is limited to 59%. By various measures, this burnup can be increased to 85%. For example, the fuel is modified and a mixture of 25% propylene and 75% kerosene is used instead of pure kerosene, and the flame holders in particular are improved and designed with multiple rows. However, energy losses due to additional internals cannot be avoided.

According to [3], the development of high-temperature materials for turbine engines in recent decades has not kept pace with the increase in process temperatures (combustion chamber temperatures).

At higher speeds, the combustion mechanism changes from heating of the unburned mixture to shock wave-induced combustion. This is also referred to as detonation. Detonations are technically difficult to control, and in engines in general are only possible with special engine concepts and are still being researched. There is a lack of decisive possibilities for controlling and stabilizing the proportions of the combustion mechanisms. According to patent specification EP 2 906795 B1, the theoretical efficiency of converting heat into theoretically usable work in engines is 27% with equal-pressure combustion (isobaric change of state), 47% with equal-space combustion (isochoric change of state) and 49% energetic efficiency by means of detonative combustion. Only through the further conversion of pressure and temperature in the Laval nozzle is a further part of the predominantly thermal energy converted into kinetic energy or usable thrust with a corresponding degree of efficiency. In the Laval nozzle, reductions in efficiency depend, among other things, on the extent of constriction and the opening/divergence of the nozzle. A part of the kinetic energy is converted into usable thrust. The technically achievable overall efficiency is thus already theoretically limited.

According to [7], the temperature behavior of the materials must be taken into account. Deformations at rocket nozzles can significantly increase the energetically and mechanically detrimental separation phenomena of the flows in nozzles. This phenomenon is generally controlled, e.g. by powerful cooling systems. However, deformations represent a serious load at maximized operating temperatures.

Generally speaking, engines are used to achieve the fastest possible and at the same time controlled reactions. The aim is to provide energy as effectively and comprehensively as possible. The drive power of chemical engines is limited in particular by the finite reaction rate. A one-sided focus on temperature as the driver of the reactions means high expenditures for cooling, materials and corresponding power losses in the maximum limit range. At the same time, the durability of the systems is currently limited.

The sole use of heterogeneous catalysts in rocket combustion chambers can lead to high fluid mechanical losses along catalyst bodies, limitation of the catalytically captured throughput of propellant, uneven reaction and premature wear of the heterogeneous catalysts themselves. In addition, controllability of the activity of fixed heterogeneous catalysts is challenging, or their permissible operating temperatures are limited. In the case of additional fixed catalytic structures, the interior of the combustion chamber must be disturbed or, alternatively, omitted. Conversely, the use of homogeneous catalysts alone can lead to high costs or, in the case of low concentration, to reduced catalytic efficiency in the combustion chamber.

However, [16] does not state that the absorbers themselves can be catalysts. Or catalytic absorber combinations are used in oxidic combustion reactions. In particular, the combination of carbon and catalysts mentioned in [16] can, in the worst case, lead to premature coking/fouling of the catalysts.

### 2.2 Solution of the Task

The task is solved by applying physical-chemical processes. The combustion kinetics are to be maximized, or the thermal efficiency during further energy conversion.

Suitable for this purpose are, for example, catalysts (acceleration of the reaction and change of temperature) and electromagnetic waves such as microwaves, radio waves, X-ray waves, or magnetic waves. Electromagnetic waves are not only suitable for ignition, but can also participate in the ongoing combustion for the most directed or increased acceleration and stimulation of the reaction. Thermocouples, generators on turbopumps, generators on the engine (e.g. induction by the movement of charges in the engine) can be used for electrotechnical supply. Compared with the actual engine, turbopumps typically use only per mille, or at most a few percent, of fuel. In contrast, the power dissipation in chemical rocket engines is typically 30-60% of the chemical power (propellant) expended. This concept can also be applied to turbopumps to reduce their energetic power dissipation as much as possible. In the case of air-breathing propulsion systems, the loss due to incomplete burnout is already of the same order of magnitude under unfavorable conditions.

The freight of catalysts (typically 1-100 μg of catalyst per kg of propellant) can be increased beyond pure chemical effectiveness to complete reaction. With higher freight rates, certain effects of catalysts can be further enhanced (e.g., up to 1-100 g of catalyst per kg of propellant). Depending on this, the reaction temperature is further minimized and the reaction rate is further increased. For this purpose, base catalytic materials can be used in addition to precious metals (e.g. iron, molybdenum, vanadium). Catalysts with a particularly high active surface area can also be used (e.g. ultra-fine particles, fiber bundles, roughened surfaces). Thermal damage to heterogeneous catalysts can be avoided by using reaction temperatures lowered with freights of homogeneous catalysts, thermally highly stressable alloys and additional reactive cooling.

In particular, the reverse case of an increased combustion chamber temperature above the generally known stoichiometric temperature, which is at least partially targeted, also applies to this concept.

This is particularly the case, for example, with:
1. stoichiometric conditions,
2. or variations of the composition possible [10] and
3. correspondingly high catalytic activity and high thermal conductivity of catalysts relevant [11] [14].

With these measures, further possibilities are available to reduce the losses at the nozzle (non-optimal relaxation under changing conditions). Kinematic jet losses can be approximately 25% of the chemical power expended by the engine [1]. Thermal losses can typically result in the same order of magnitude and are also contributed to by the design of the throat at the nozzle (friction/heat transfer at the narrowest cross-section).

The freights on:
1. catalysts
2. absorbers
3. metal particles
4. Intensity of electromagnetic waves
   can be specifically adapted to the external pressure.

In [4], it is pointed out that changing the combustion chamber pressure can be a possible solution for controlling the detachment zone of corresponding nozzles at variable external pressures (Bell nozzles). However, to avoid the disadvantage of thrust collapses, a variable mixing ratio of fuel components is preferred. This concept, on the other hand, works by varying the loads of catalysts, metal particles, or dose rates of electromagnetic waves in order to avoid shear collapses as far as possible. Conversely, [4] proves the positive influence of high combustion chamber pressure on thrust.

For internal combustion engines, patent specification EP 1 833 594 B1 “Catalytic combustion reaction” refers in this respect to the fact that a higher pressure can be achieved in the engine with the catalytic system of the invention. According to patent specification EP 1 833 594 B1, this higher pressure can be maintained over a longer period of time.

### 2.3 Advantages of the Invention

In chemical rockets, about 90% of the launch mass consists of propellant (e.g., liquid oxygen and RP-1/kerosene or liquid hydrogen). Through better energetic utilization, the percentage of payload should be increased as much as possible. If the required propellant fraction is reduced, less propellant is to be accelerated along with it.

In general, the following applies with this concept: The critical area of rockets is designed for the respective critical Mach number. Up to the critical Mach number, thermal acceleration is possible; beyond this, further acceleration is required, e.g. with a Laval nozzle, in order to be able to convert as much as possible of the thermal and pressure-bound energy of the supporting mass (e.g. burnt fuel) into usable thrust. In the case of Laval nozzles, this is achieved by subsequent expansion. Some of the energy cannot be converted into usable thrust, e.g. due to transverse acceleration and temperature losses at the constriction. With catalytic converters, a forward adaptation of the combustion chamber with reduced necking is possible. At the same time, the combustion chamber can be reduced in size, e.g., by increasing the reaction rate. In principle, catalysts do not change the reaction enthalpy, so that a higher useful power can be decoupled from the engine and at least the same reaction rate, and the power loss that must necessarily be decoupled is reduced (less cooling). Also, due to the faster reaction, a steeper increase of the thermodynamic change of state in the pV diagram is possible. In rocket engines, combustion is usually uniformly isobaric due to the design. With a corresponding increase, an isobaric change of state can be converted to an equal-space combustion “isochoric” with higher thermal efficiency—with appropriate design measures. Appropriate intermediate stages should also be aimed for. In the most extreme case, further conversion to detonative combustion is possible. This is relevant, for example, for detonation engines. Catalysts, possibly in conjunction with electromagnetic waves, can also regulate and support processes in future detonation engines.

By using a targeted turbulent combustion (higher mean or partial flame velocity), or thermally effective equal-space combustion with adapted change of state, a higher proportion of the chemical energy is to be converted directly into kinetic energy. In order not to damage the engine, the pressure surges are limited or pulsed. Heterogeneous or homogeneous catalysts (e.g. platinum, gold, etc.) can be used for this purpose.

As a consequence of these various possible solutions, the combustion chamber can be adapted to the desired extent in order to achieve further effects. For example, the combustion chamber can optionally be enlarged to achieve higher fuel throughputs. Alternatively, the combustion chamber can be made smaller as combustion is optimized. The constriction of the nozzle can also be reduced or, if necessary, omitted, or other combustion chambers can be selected (e.g. conical or tubular).

Cooling of the engine is simplified and service life/safety increased. Simpler and less expensive materials (e.g. steel) with reduced high-temperature strength can be used. There are more complex engineering relationships here as well. For example, a reduced combustion temperature means that less surface area in the cooling channels needs to be wetted. This means that the cooling ducts in the engine walls can be enlarged. Alternatively, individual cooling ducts can be dispensed with or the distance to the combustion chamber can be increased. If the diameter of the cooling ducts is increased or their density reduced, the mechanical load-bearing capacity of the engine walls can be increased and tolerance to temperature fluctuations improved. In addition, fluidic resistances of the cooling ducts to the turbopumps are reduced. The turbine characteristic curve is “relieved” in terms of energy. Higher mass flows can be introduced at the same pump capacity, or the service life of the turbopumps can be maximized. Optionally, the production of engines, turbopumps or, for example, cooling ducts can be simplified. Alternatively, engine walls can also be “thermally” slimmed. This, in conjunction with the higher mechanical load capacity and possible lower combustion temperature, facilitates effective combustion at high pressures. The development of high-temperature materials has not yet been able to keep pace with the ever higher combustion temperatures in engines (e.g. turbine engines).

Also, according to [3] e.g. FIG. 20.1 page 368, the optimum pressure ratio (e.g. in turbine engines) depends on the combustion chamber temperature. With reduced combustion chamber temperature, the optimum pressure ratio can be significantly reduced, in some cases extremely. One sticking point with turbine engines, or air-breathing engines, is the technically limited range of use due to the simplest and most robust design possible. This geometric and mechanical limitation can generally be extended by this concept by means of variable loads of catalysts and variable dose rates of electromagnetic waves (e.g. microwaves). There are generally always total pressure losses associated with compression (e.g., frictional). Reduced compression in the engine can thus limit energetic losses. Early use of ramjets is energetically advantageous (e.g. subsonic ramjets).

Conversely, when using heterogeneous catalysts with high thermal conductivity or non-uniform mixing of the fuel, the reaction temperature can thus be increased above the stoichiometric level if desired. This is referred to as superadiabatic [10] [11] [14]. Superadiabatic changes of state usually possess a high temperature gradient. High temperature gradients can facilitate cooling on the outside of the combustion chamber walls inside the engine. One possible application is to focus combustion inside the engine under high-speed conditions.

The Adapted Process Concept is thus intended to permit the widest possible use of engines, especially in the case of highly variable parameters such as the approach velocity during a vertical takeoff. The current technically possible limit range is to be extended as reliably and efficiently as possible. The permissible and safe operation in the burnout phase, or with fuel residues, can also be further exploited by the supporting measures. For example, the decreasing combustion chamber pressure must be stabilized by additional loads of catalysts. Flushing the tanks and the piping system with controlled and higher residual pressure reduces unused residual fuel. Residue-free burnup at injection and in the combustion chamber improves the durability of engine components.

This Adapted Process Concept can be used to reach the operating temperature of engines at an early stage and to increase thrust in the initial phase. The use of this concept is also advantageous for controlling thrust engines below maximum speed, for example, in order to support and specifically adapt the reduced reaction in the combustion chamber.

The rocket can be accelerated faster to reduce e.g. energetic losses due to gravitational acceleration.

Another influencing factor, e.g. in the case of larger engines, is the required uniformity of combustion to prevent damage. Catalysts and electromagnetic waves can be used to control the unavoidable fluctuations in the reaction or to reduce fluctuations.

In air-breathing engines, burnout can be increased and thermally adjusted. Reducing the number of ignition devices required in the engine flow is advantageous from an energy point of view. In extreme cases, it is also possible to dispense with these ignition devices and use self-ignition (e.g. when the operating temperature is reached). This is particularly relevant for ramjets with otherwise partly multi-row flame holders. As a special application case, the use with air-breathing engines such as subsonic ramjets, but also lesser-known combination engines and special forms such as rocket ramjets is possible.

A valuable additional benefit of this concept is the introduction and maintenance of a heat-reflecting layer in the respective firing chamber. In [4] it is stated that the heat reflection of gold coatings is over 99% of the infrared radiation. This is all the more interesting because heat radiation increases disproportionately with increasing temperature compared to heat conduction. The coating thickness specified in [4] for this purpose is only 2 μm thick and can be applied by electroplating, for example. According to [5], this is already state of the art and ready for the market. Platinum coatings are advertised for more aggressive environments. The added value of this concept lies in the supplementation with additional loads of homogeneous catalysts to prevent fouling and coking on the catalyst layers. In addition, this concept according to patent application U.S. Ser. No. 17/650,537, focuses on high-temperature alloys which also offer higher thermal and mechanical resistance in corresponding combustion chambers. This in turn limits thermal losses and simplifies the cooling, or heat resistance, of the materials by providing additional functional insulation. According to [1], in chemical rocket engines, thermal losses can result in about 25% of the chemical power expended. A coating of the thermally highly stressed constriction of classic rocket engines, or of the entire combustion chamber, is thus technically relevant. The achievable throughput can be increased with the same surface area.

The optimized combustion also facilitates the use of air-breathing engine systems. Compared with conventional rocket engines, oxidizer can be saved (approx. 75% of the total take-off mass), or fuel (approx. 15% of the total take-off mass). It also facilitates the use of advanced nozzle concepts (e.g. aerospikes), as these are particularly thermally demanding.

Superior effects on catalytic combustion (patent application U.S. Ser. No. 17/650,537 of the same name applicant) and electromagnetic excitation (patent application U.S. Ser. No. 17/653,910 of the same name applicant) on the combustion chamber geometry are the subject of this adapted process concept.

Übergeordnet kann auch der Transport latenter Warme von katalytischen Absorbern bei Phasenanderungen genutzt werden.

Higher-level transport of latent heat from catalytic absorbers during phase changes can also be used.

### SUMMARY OF THE INVENTION

A distinction must be made between forms of energy supply. For example, chemical energy can be released with maximum thrust through maximum temperature with losses. This process concept focuses on variable physico-chemical measures, in particular by catalytic combustion supported by means of electromagnetic excitation. Further possibilities with regard to thermodynamic changes of state are to be opened up. In addition to classical isobaric state changes, isochoric state changes/intermediates, and also detonative reactions become relevant with this adapted process concept.

The task of the invention is to develop an alternative to thermal maximization, or thermo-chemistry, in order to reduce energy losses as far as possible (e.g. by adapting the combustion chamber, constriction at the nozzle throat and nozzle) and to accelerate the reaction. Further, improved controllability in rigid geometries is also sought.

The invention is said to be suitable in principle for liquid and hybrid propulsion systems.

### BRIEF DESCRIPTION OF THE DRAWING FIG.S

FIG. 1: Energy diagram of an engine—state of the art.

In this FIG. a simplified energy scheme is shown.

FIG. 2: Energy diagram of an engine—performance concept.

In this FIG. another simplified energy scheme is shown.

FIG. 3: Energy flow—adaptation by process concept.

In this FIG. a Sankey diagram is shown.

FIG. 4: Process control.

In this FIG. schematics are linked together.

FIG. 5: Schematic—laminar combustion.

In this FIG. a schematic for laminar combustion is shown.

FIG. 6: Combustion chamber for rocket engines according to [1].

In this FIG. various basic shapes for combustion chambers are shown.

FIG. 7: Thermal insulation by reflection.

The FIG represents the scheme for heat reflection by means of catalytic coating.

The above designs are examples. Further variants are covered in the patent specification, or claims (e.g., to generators for turbopumps/turbopumps).

### DETAILED DESCRIPTION

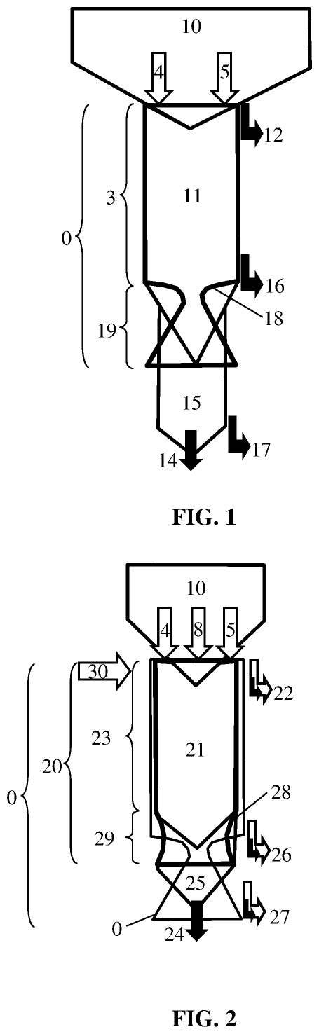

FIG. 1 shows a simplified energy diagram.

Chemical energy (10) is bound in the reducing agent (4)—e.g. H₂ and oxidizing agent (5)—e.g. O₂. The reactants, or the fuel, react in the combustion chamber (3).

In general, the following applies to chemical engines (0): The conversion of the chemically bound energy (10) provides predominantly thermal energy (11) with lossy conversion (12). Furthermore, kinetic energy (15) is obtained by lossy conversion (16) at the constriction of the nozzle (18) and nozzle itself (19). This is because it is only through the lossy thermodynamic changes of state at the nozzle throat (18) and nozzle (19) that a further part of this thermal energy (11) is converted into kinetic energy (15) in the direction of thrust (14). Further losses occur at the engine, for example, as a result of the expansion at the nozzle outlet (17) not being fully optimal, e.g. due to variable external pressure during vertical takeoff.

FIG. 2 contains another simplified energy scheme.

Compared to the embodiment FIG. 1, with the present process and power concept the geometry of the chemical engine (20) is changed in length (reduction of friction, material), diameter (reduction of material) and constriction of the nozzle (28) (reduction of radial acceleration, friction, etc.) and nozzle (29) (reduction of divergence). Alternatively, the combustion chamber (23) can be made tubular or conical, if necessary, to further limit losses.

For comparison, the design of an engine (0) with a conventional design is shown. This also applies analogously to other engine types such as air-breathing engines (e.g. ramjets).

During the conversion of chemical energy (10) into thermal energy (21), the energetic losses (22) are minimized by higher reaction rates and, if necessary, metered turbulent combustion or combustion with adapted pressure during combustion. This is supported by the addition of homogeneous catalysts (8), e.g. of platinum. In addition, the combustion chamber (20) can be catalytically coated, or coated with a heterogeneous catalyst, e.g. in the combustion chamber head. By further coating in the rest of the combustion chamber, the heat radiation on the combustion chamber walls can be reduced (reflection). A variable dose rate of injected electromagnetic waves (30)—e.g. in the form of magnetic waves or microwaves, or radio waves can have a targeted effect on the reaction in the combustion chamber (23). Advantageously, the electromagnetic waves are coupled to injected homogeneous catalysts (8). These have corresponding paramagnetic properties with a high electromagnetic absorption capacity. This reduces absorption compared to purely dielectric properties (e.g. of propellants). The property of electromagnetic waves (30) is used, as in the case of microwaves, for example, to increase the reaction rate (Patent application DE 39 03 602 A1) and at the same time reduce the combustion temperature. An electrotechnical supply can optionally be provided by generators on the turbopump, generators on the engine, or by thermocouples on the engine. Electromagnetic waves, e.g. magnetic waves, can also be used to selectively align or equalize the ionized substances in the combustion chamber.

Due to higher flow velocity, the constriction of the nozzle (28) is reduced. The energetic losses (26) during the conversion of thermal energy (21) into kinetic energy (25) are reduced. Kinematic losses (27) are reduced due to the reduced length and inclination of the nozzle (29). The loads on homogeneous catalysts (8) are adapted to the variable external pressure during vertical starts. Energetic losses are thus further reduced. The speed at the nozzle outlet of the engine can also be controlled and adjusted via injected shafts (30) in the combustion chamber head to further reduce kinematic losses (27) at the nozzle outlet (24) of the engine.

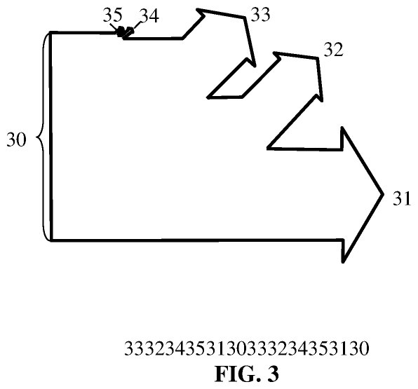

FIG. 3 shows a Sankey diagram.

The adapted power concept increases the fraction of a rocket engine (typically 40-70%) or air-breathing engine that can be used as thrust (31). In summary, an alternative to thermo-chemistry is to be achieved by physical-chemical measures, or physico-chemical.

The kinematic losses (32) can be reduced by modifying the combustion chamber design, but also by adapting the outlet pressure at the nozzle of the engine to the variable external pressure. This is relevant, for example, in the case of a vertical takeoff.

The thermal losses (33) in the engine are reduced, e.g. by increasing the mass flow rate.

Wall losses (34) are reduced by adapting the geometry and improving combustion kinetics. In the same context, combustion losses are reduced (35).

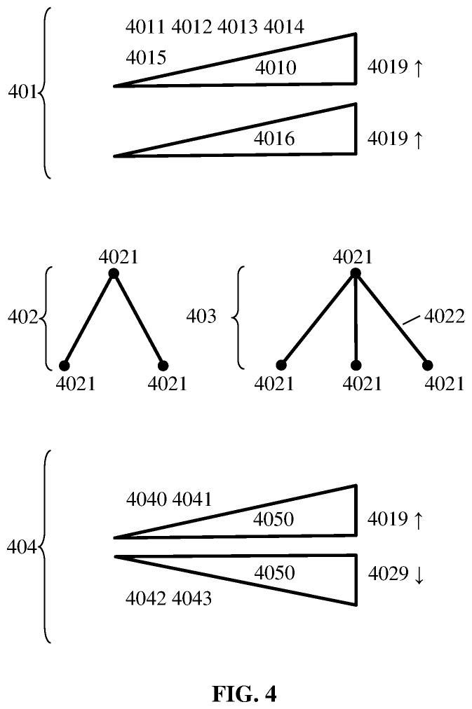

FIG. 4 links other schemes together.

For the activity of individual catalysts (401), a general tendency is indicated with an increase triangle (4010) is indicated.

The activity of the catalysts (401) increases in particular with:
1. higher temperature of the catalyst (4011),
2. larger specific surface of the catalyst (4012)
3. proximity to the reaction or to the combustion chamber wall (4013)
4. possibly with a higher number of different catalysts, since certain catalysts can have a stabilizing or reinforcing effect on one another, e.g. as promoters (4014)

Also, the overall activity can be increased by higher quantitative concentration of the catalysts (4015) can be increased. Additionally, the activity of the catalyst (401) can be enhanced by electromagnetic dose rate (4016) (e.g., microwaves). Catalysts, such as platinum generally have paramagnetic properties. These properties are superior to pure dielectricity of propellant for coupling electromagnetic dose rate (4016). At the same time, electromagnetic dose rate (4016) can be used to ignite or stimulate the ionized flame front. Also, electromagnetic dose rate increases the activity of catalysts. At the same time, catalysts decrease the required activation energy for chemical reactions. Thus, with concentration of catalysts (4015) and the level of electromagnetic dose rate (4016), two complementary and reinforcing control actuators are available to increase the activity of catalyst (401) to a maximum.

That means by increasing temperature (4011), specific surface area (4012), proximity to the reaction (4013), number of different catalysts (4014) and quantitative concentration (4015), growth (4019) of activity of catalysts occurs.

In the reaction area, a reaction chain (402) or an increase in the number of reactions (4021) to the center of the reaction region, e.g., due to an increase in temperature, available activation energy, number of reactive intermediates (e.g., radicals), etc.

Further on, reaction chains without effective catalysts (402) and reaction chains with effective catalysts (403) are shown. In exothermic reactions (4041), starting products are converted into reaction products. After the supply of activation energy, exothermic reactions release energy. Some of the activation energy can be extracted from the environment, or released energy can be released into the environment. An increase in the activity of the catalysts (401) results in an additional branching at the reaction chain (4022). On the one hand, the required activation energy can be reduced by catalysts. On the other hand, in exothermic reactions additional reaction enthalpy is released in the same time due to higher reaction rates.

For this purpose, the control system of the combustion chamber (404), or the basic tendencies of the reaction are shown in generalized form. The tendencies of the reaction (404) are decisively usable for the design and operation of the combustion chambers. This is the object of invention of this adapted process concept. An energetic optimization of process parameters (e.g. pressure and temperature) and combustor geometries (e.g. the necking) is aimed at.

In this embodiment, some parameters can be increased with increase of the actuators (4010 and 4016), with conventional isobaric change of state (4050). The parameters to be increased in this embodiment are reaction speed (4040) and pressure (4041). In an alternative embodiment, the pressure can be stabilized, for example, or lowered. On the other hand, parameters such as temperature (4042) and number of free reactants (4043), e.g. unburned components, or also pollutants produced, can also be lowered. Increasing the actuators of the control system (4010 and 4016) results in a decreasing tendency (4029). The associated tendency for this change of state is isobaric (4050). In an alternative embodiment, the temperature can alternatively be increased or stabilized in the event of a large increase in the reacting material flow.

In an alternative embodiment, a superadiabatic reaction may also be can be brought about at a temperature above the reaction temperature under stoichiometric conditions.

In principle, by adding catalysts, not only can the completeness of the reaction be aimed at, but also, in addition, the reaction rate can be increased if the loads are further increased. This has the effect of lowering the activation energy as well as the temperature of the combustion chamber. And it allows to increase the mass flow.

Optionally, the temperature can be lowered and, in particular, the reaction temperature can be increased to superadiabatic conditions if the catalytic activity and mass flow are appropriate. In this case, reaction temperatures can be achieved which are higher than the temperature under stoichiometric conditions [10] [11] [14]. Heterogeneous catalysts with high thermal conductivity can be used for this purpose.

Alternatively, it is also possible to control the pressure and speed of the supporting agent.

This is supported by electromagnetic waves (e.g. microwaves), which can further adjust the trend of the reactions.

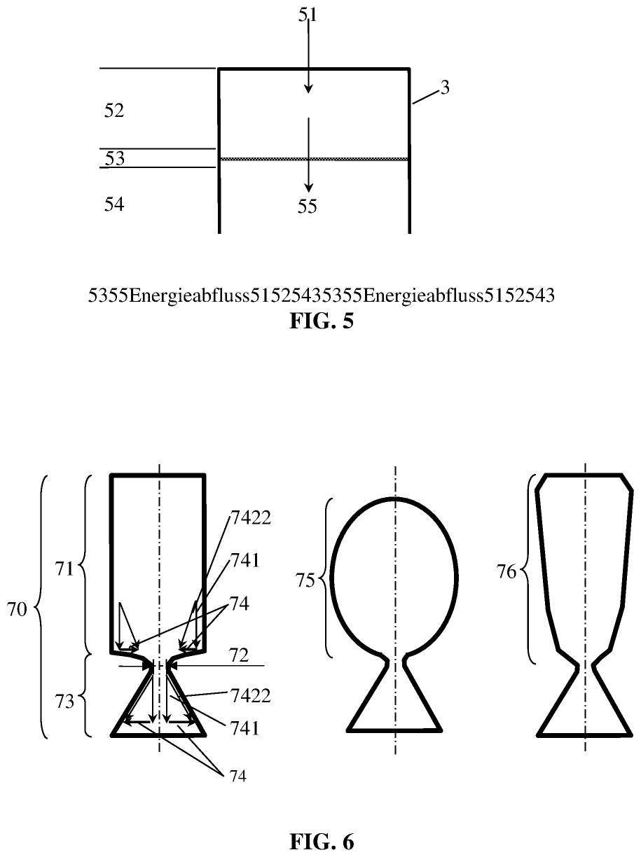

FIG. 5 illustrates a scheme for laminar combustion.

Laminar combustion takes place in the combustion chamber (3) under uniform conditions. Fuel is injected (51) into the combustion chamber (3). Between the unburned fuel (52) and the burned fuel (54) there is a uniform zone of combustion (53). However, trailing flame fronts (or pressure surges) and leading pressure surges can cancel each other out or reduce each other. In the worst case, this can result in energy losses.

The result is a uniform situation in the direction of propagation (55).

FIG. 6 illustrates various basic shapes for combustion chambers according to [1].

In this FIG. various basic shapes for combustion chambers are shown.

An engine (70) is often manufactured with a cylindrical combustion chamber (71). With cylindrical combustion chamber (71), combustion is accelerated to the critical area (72) to the critical Mach number. In FIG. 6, the dimension arrows are shown closed. Above the critical Mach number, thermal acceleration is no longer possible and further acceleration takes place in the Laval nozzle (73) with corresponding efficiency. Laval nozzle (73) enables partial conversion of thermal energy into kinetic energy to achieve the highest possible thrust. At the Laval nozzle (73), part of the energy in the engine (70) is transferred thermally to the nozzle wall. Another part cannot be further converted into usable kinetic energy (74) due to friction in the engine (70) and transverse acceleration at the incision (71) and expansion of the nozzle (72). The usable vector components (741) and the resulting force components (742) are shown in simplified form in the sectional plane of the drawing. In the spatial representation, further components arise which cannot be used energetically in thrust. The vectors are each shown with arrowheads open on one side.

Similarly, in a spherical combustion chamber (75) and in a pear-shaped combustion chamber (76), the flow cross-section is first narrowed (71) and then widened (72) in the nozzle.

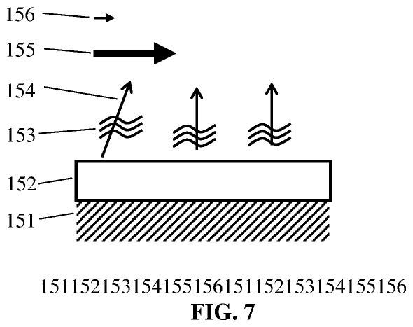

FIG. 7 illustrates a schematic for heat reflections off a catalytic coating.

In this general embodiment, the principle of heat reflection is shown very roughly. The combustion chamber wall (151) is catalytically coated (152). In addition to the advantages for the chemical reaction of oxidizer and reducing agent (155), e.g. with increased mass flows, the coating can also influence the thermal properties of the combustion chamber wall (151).

In this general embodiment, the principle of heat reflection is shown very roughly. The combustion chamber wall (151) is catalytically coated (152). In addition to the advantages for the chemical combustion of oxidizer and reducing agent (155), the coating can also influence the thermal properties of the combustion chamber wall (151).

Gold, for example, has a high reflectivity in the infrared range even at low layer thicknesses. However, gold is mechanically soft and platinum, for example, is generally better suited for more aggressive environments.

In this embodiment, an alloy of 55% platinum with 45% rhenium is preferred for the catalytic coating in accordance with patent specification U.S. Ser. No. 17/650,537. The permissible melting temperature of the alloy is over 2,673° K or 2,400° C. As a result, the alloy has a high resistance to sintering and premature damage to the catalytic activity. In addition, rhenium has positive mechanical properties and an effect against coking. The coating thickness is a maximum of 100 μm, but at least 2 μm to effectively reflect thermal radiation.

By additionally introducing homogeneous catalysts (156) into the fuel (155), the catalytic coating (152) of the combustion chamber wall (151) is refreshed and protected as far as possible against fouling/coating.

Thermal radiation (153) onto the combustion chamber wall (151) is reflected (154) by the catalytic coating (152). Thermal losses are reduced and the cooling of the combustion chamber (151) is relieved.

What is described herein are specific examples of possible variations on the same invention and are not intended in a limiting way. The invention can be practiced using other variations not specifically described above.

What is claimed is:

1. A process for ignition or reaction in chemical engines or turbines (e.g. rocket engines, gas turbines or gas turbines for turbopumps), air-breathing engines, comprising:
At least one catalytic absorber for electromagnetic waves and at least partial excitation by means of electromagnetic waves, both in combination with so-called process parameters and combustion chamber properties comprising at least one of the following process parameters: Reaction rate, reaction temperature, reaction pressure, flow velocity in the combustion chamber, and additionally having at least one of the following combustion chamber properties: permissible mass flows, cooling, combustion chamber geometry, combustion chamber length, combustion chamber width, combustion chamber cross section, constriction of the nozzle throat, nozzle length, nozzle inclination, the fuel concentration in air-breathing engines, compressor pressure ratio or compressor pressure ratios of several components of the engine.

2. A process according to claim 1, comprising:
At least one homogeneous catalyst (e.g., of one or more platinum group metals, element(s) of subgroups IV, V, VI, VII, VIII, I and II) introduced into the combustion chamber.

3. A method according to claim 1 comprising:
other metallic additives are introduced into the combustion chamber that are not used as electromagnetic absorbers and are not catalytic.

4. A method according to claim 1 comprising:
at least one heterogeneous catalyst (e.g., of one or more platinum group metals, element(s) of the IV, V, VI, VII, VIII, I and II subgroups) is placed in the combustion chamber.

5. A method according to claim 1 comprising:
a turbulent combustion is carried out selectively or intermittently or partially.

6. A method according to claim 1 comprising:
Pressure surges or pulses and any of the foregoing regulated by at least one of: varying loads of homogeneous catalysts as absorbers, further loads of metallic additives, level of electromagnetic dose rate intensity, pulsing of electromagnetic waves, selective excitation of propellant constituents.

7. A method according to claim 1 comprising:
At least one other electromagnetic wave type, such as microwave, magnetic wave, radar wave, x-ray wave.

8. A method according to claim 1 comprising:
the temperature gradient is influenced by heat reflection of heterogeneous catalysts (e.g. platinum) in the engine (e.g. internals), or the combustion chamber wall, and the heterogeneous catalysts are kept free from aging or fouling by additionally introduced loads of homogeneous catalysts.

9. A method according to claim 1 comprising:
at least temporarily reacting by means of isochoric or detonative changes of state at least a portion of the propellant.

10. A method according to claim 1 comprising:
a combustion chamber pressure which is specifically directed to the best possible compression efficiency of individual assemblies (e.g. the inlet, or the nozzle), or the overall engine.

11. A method according to claim 1 comprising:
stabilizing or adjusting at least one process parameter, such as the temperature or pressure in the combustion chamber, by means of catalytic absorbers or electromagnetic excitation during the combustion termination phase of the engine or when the fuel mass flow of the engine is changed.

12. A method according to claim 1 comprising:
where applicable, rendering existing fuel residues in tanks or lines useful to the engine by at least one of: catalytic absorbers, or assisting the reaction by electromagnetic waves (e.g., microwaves).

13. A method according to claim 1 comprising:
by the additions of catalytic absorbers or other metallic additives in which latent heat is used by at least one phase change for at least one adjustment of the so-called process parameters or the permissible combustion chamber properties: Temperature equalization, temporary cooling of at least one engine area such as the constriction of the nozzle, performing volume change work, pressure lowering during cooling.
